(19) United States
(12) Patent Application Publication
(10) Pub. No.: US 2021/0207845 A1
(43) Pub. Date: Jul. 8, 2021

(54) Inline Water Heating Device

(71) Applicant: Matthew Ulrich, Marietta, PA (US)

(72) Inventor: Matthew Ulrich, Marietta, PA (US)

(21) Appl. No.: 16/735,798

(22) Filed: Jan. 7, 2020

(51) Int. Cl. F24H 1/14

(52) U.S. Cl. CPC F24H 1/142

(57) ABSTRACT

An inline water heating device for reducing heating costs and wasted water includes a pipe and a heating element. The pipe has opposed ends that are singly couplable to a water inlet and a water outlet so that water flows through an interior space that is defined by the pipe. The heating element is disposed longitudinally within the interior space and is electrically insulated from both the pipe and the water that flows through the interior space. The heating element is powered to heat the water that flows through the pipe.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to water heating devices and more particularly pertains to a new water heating device for reducing heating costs and wasted water.

### (2) Description of Related Art Including Information Disclosed Under 37 CFR 1.97 and 1.98

The prior art relates to water heating device. Prior art devices for heating water within a segment of pipe generally comprise a heat source that is external to the segment of pipe.

### BRIEF SUMMARY OF THE INVENTION

An embodiment of the disclosure meets the needs presented above by generally comprising a pipe and a heating element. The pipe has opposed ends that are configured to be coupled singly to a water inlet and a water outlet. The pipe is configured for water to flow through an interior space that is defined by the pipe. The heating element is disposed longitudinally within the interior space and is electrically insulated from both the pipe and the water that flows through the interior space. The heating element is powered to heat the water that flows through the interior space from the water inlet to the water outlet.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of an inline water heating device according to an embodiment of the disclosure.

FIG. 2 is an end view of an embodiment of the disclosure showing internal threading.

FIG. 3 is an end view of an embodiment of the disclosure showing external threading.

FIG. 4 is a top view of an embodiment of the disclosure.

FIG. 5 is a cross-sectional view of an embodiment of the disclosure.

### DETAILED DESCRIPTION OF THE INVENTION

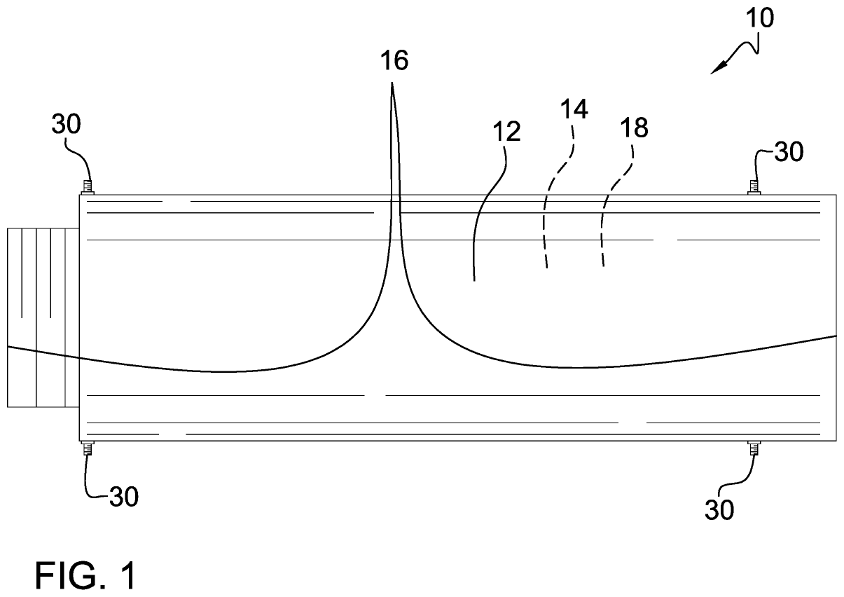

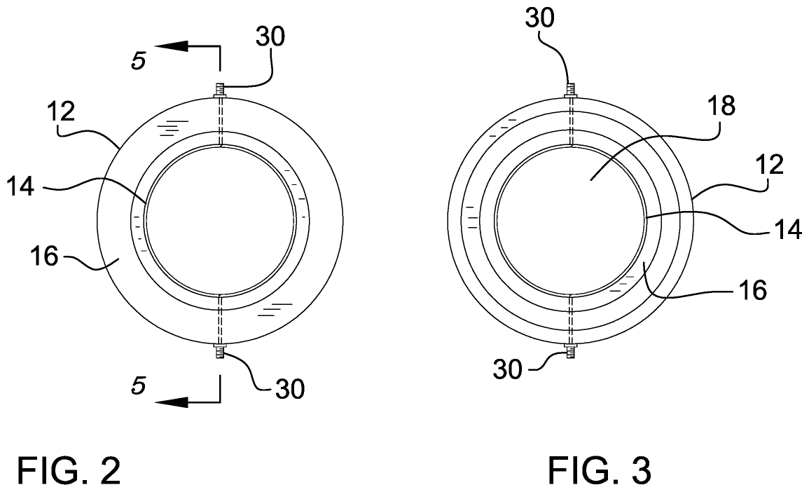

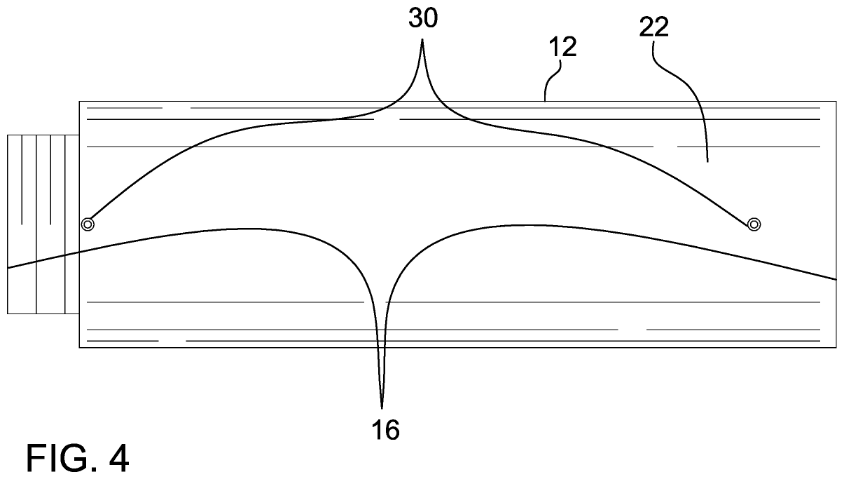

With reference now to the drawings, and in particular to FIGS. 1 through 5 thereof, a new water heating device embodying the principles and concepts of an embodiment of the disclosure and generally designated by the reference numeral 10 will be described.

As best illustrated in FIGS. 1 through 5, the inline water heating device 10 generally comprises a pipe 12 and a heating element 14. The pipe 12 has opposed ends 16 that are configured to be coupled singly to a water inlet and a water outlet so that the pipe 12 is configured for water to flow through an interior space 18 that is defined by the pipe 12.

One of the opposed ends 16 may internally threaded while the other of the opposed ends 16 may be externally threaded. The present invention also anticipates other coupling means for connecting the pipe 12 to the water inlet and the water outlet, such as, but not limited to, sweating, quick connects, and the like.

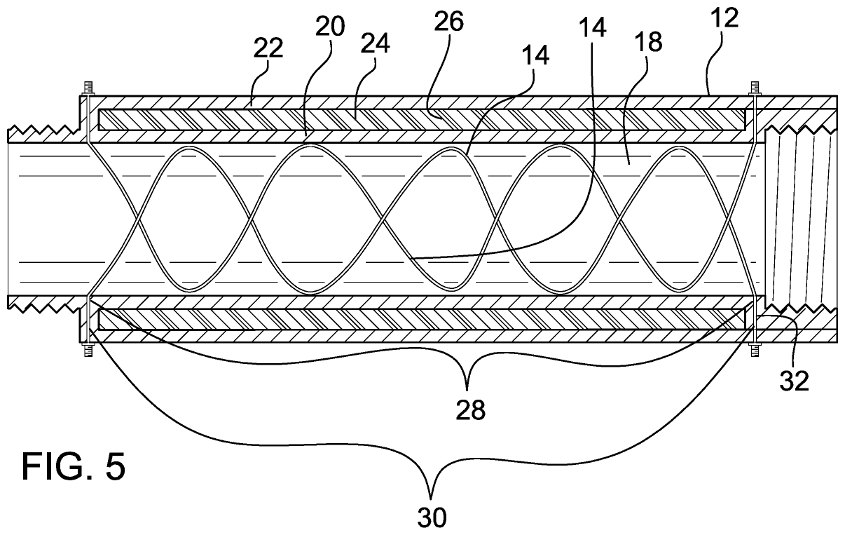

The pipe 12 comprises an inner tube 20 and an outer tube 22 that define an internal space 24, as shown in FIG. 5, that is configured to insulate the interior space 18. The internal space 24 may be substantially occupied by an insulator 26. The present invention also anticipates the internal space 24 being evacuated or filled with a noble gas.

The heating element 14 is disposed longitudinally within the interior space 18, as shown in FIG. 5. The heating element 14 is electrically insulated from both the pipe 12 and the water that flows through the interior space 18. The heating element 14 is powered to heat the water that flows through the interior space 18 from the water inlet to the water outlet. The device 10 is anticipated to be useful in a wide variety of applications, including but not limited to, under-sink, in-wall, and hose end applications. For under-sink and in-wall applications, the device 10 heats the water in the interior space 18 when the water outlet is closed, thus providing an instant source of hot water.

The heating element 14 has opposed termini 28. Each opposed terminus 28 has a connector 30 coupled thereto and extending through a wall 32 of the pipe 12 proximate to an associated opposed end 16 of the pipe 12. The connectors 30 are configured to operationally couple the heating element 14 to at least one of a battery (not shown) and an electrical circuit (not shown) to power the heating element 14. The present invention also anticipates a controller (not shown) operationally coupled to the heating element 14 and the at least one of the battery and the electrical circuit to selectively control heat output of the heating element 14.

The heating element 14 extends spirally through the interior space 18 to efficiently heat the water. The heating element 14 is one of a pair of heating elements 14 so that the pair of heating elements 14 has a helical configuration, as shown in FIG. 5.

In use, the pipe 12 is threadedly coupled to the water inlet and the water outlet. The connectors 30 are coupled to at least one of the battery and the electrical circuit to power the heating element 14 to heat the water in the interior space 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. An inline water heating device comprising:
a pipe having opposed ends configured for being coupled singly to a water inlet and a water outlet, wherein the pipe is configured for flowing of water through an interior space defined by the pipe; and
a heating element disposed longitudinally within the interior space, the heating element being electrically insulated from the pipe and the water flowing through the interior space, the heating element being powered to heat the water flowing through the interior space from the water inlet to the water outlet.

2. The inline water heating device of claim 1, wherein one of the opposed ends is internally threaded, the other of the opposed ends is externally threaded.

3. The inline water heating device of claim 1, wherein the pipe comprises an inner tube and an outer tube defining an internal space configured for insulating the interior space.

4. The inline water heating device of claim 3, wherein the internal space is substantially occupied by an insulator.

5. The inline water heating device of claim 1, wherein the heating element has opposed termini, each opposed terminus having a connector coupled thereto and extending through a wall of the pipe proximate to an associated opposed end of the pipe, wherein the connectors are configured for operationally coupling the heating element to at least one of a battery and an electrical circuit for powering the heating element.

6. The inline water heating device of claim 1, wherein the heating element extends spirally through the interior space.

7. The inline water heating device of claim 6, wherein the heating element is one of a pair of heating elements such that the pair of heating elements has a helical configuration.

8. An inline water heating system comprising:
a water source fluidically coupled to a water inlet and configured for flowing of water from the water source to the water inlet;
a water outlet configured for dispensing water;
a pipe having opposed ends coupled singly to the water inlet and the water outlet such that water flows from the water inlet to the water outlet through an interior space defined by the pipe; and
a heating element disposed longitudinally within the interior space, the heating element being electrically insulated from the pipe and the water flowing through the interior space, the heating element being powered to heat the water flowing through the interior space.

9. The inline water heating system of claim 8, wherein the pipe comprises an inner tube and an outer tube defining an internal space configured for insulating the interior space.

10. The inline water heating system of claim 9, wherein the internal space is substantially occupied by an insulator.

11. The inline water heating system of claim 8, wherein the heating element has opposed termini, each opposed terminus having a connector coupled thereto and extending through a wall of the pipe proximate to an associated opposed end of the pipe, wherein the connectors are configured for operationally coupling the heating element to at least one of a battery and an electrical circuit for powering the heating element.

12. The inline water heating system of claim 8, wherein the heating element extends spirally through the interior space.

13. The inline water heating system of claim 12, wherein the heating element is one of a pair of heating elements such that the pair of heating elements has a helical configuration.

14. An inline water heating device comprising:
a pipe having opposed ends configured for being coupled singly to a water inlet and a water outlet, wherein the pipe is configured for flowing of water through an interior space defined by the pipe, one of the opposed ends being internally threaded, the other of the opposed ends being externally threaded, the pipe comprising an inner tube and an outer tube defining an internal space configured for insulating the interior space, the internal space being substantially occupied by an insulator; and
a heating element disposed longitudinally within the interior space, the heating element being electrically insulated from the pipe and the water flowing through the interior space, the heating element being powered to heat the water flowing through the interior space from the water inlet to the water outlet, the heating element having opposed termini, each opposed terminus having a connector coupled thereto and extending through a wall of the pipe proximate to an associated opposed end of the pipe, wherein the connectors are configured for operationally coupling the heating element to at least one of a battery and an electrical circuit for powering the heating element, the heating element extending spirally through the interior space, the heating element being one of a pair of heating elements such that the pair of heating elements has a helical configuration.
